(19) United States
(12) Patent Application Publication
(10) Pub. No.: US 2026/0104373 A1
(43) Pub. Date: Apr. 16, 2026

(54) MATERIAL CHARACTERIZATION USING GREY LEVEL MEASUREMENT AND X-RAY CHARACTERIZATION

(71) Applicant: Applied Materials Israel Ltd., Rehovot (IL)

(72) Inventors: Dror Shemesh, Hod Hasharon (IL); Eran Gal, Yehiam (IL); Tair Duvdevani-Gabbay, Ramat-Gan (IL); Michal Eilon, Beit-Elazari (IL); Roy Assulin, Be'er Ya'akov (IL)

(73) Assignee: Applied Materials Israel Ltd., Rehovot (IL)

(21) Appl. No.: 18/916,358

(22) Filed: Oct. 15, 2024

(51) Int. Cl. G01N 23/2251

(52) U.S. Cl. CPC G01N 23/2251; G01N 2223/401; G01N 2223/6116

(57) ABSTRACT

A non-destructive and localized method for characterization of samples using high sampling rate scanning electron microscope (SEM) and low sampling EDX, by building a correlation plot, thereby allowing a fast characterization of features that typically require EDX analysis.

### TECHNICAL FIELD

The present disclosure relates generally to material characterization based on grey levels and X-ray characterization.

### BACKGROUND OF THE INVENTION

Material characterization/metrology plays a pivotal role in research, development, and manufacturing processes. For example, wafer manufacturing processes require implementing various sample metrology techniques aimed to characterize the physical, chemical and electronic properties of semiconductor materials and devices at various stages of fabrication. This aids in acquiring crucial data regarding the efficacy of the manufacturing processes and enabling timely adjustments to reduce defects, enhance yield, reliability and quality of the manufactured devices. Current material metrology methods are typically based on long-cycle destructive methods, which cannot be used in High Volume Manufacturing (HVM). However, as the semiconductor industry approaches device shrinking limits and embraces advancements in manufacturing and design technologies, there arises a need for corresponding material metrology methods.

Hence, there is a need in the art for a fast and non-destructive method for material characterization to facilitate and/or optimize the manufacturing processes.

### BRIEF SUMMARY OF THE INVENTION

Aspects of the disclosure, according to some embodiments thereof, relate to specimen/material characterization. More specifically, but not exclusively, aspects of the disclosure, according to some embodiments thereof, relate to material characterization using X-ray measurement-supported scanning electron microscope (SEM), thereby allowing a fast SEM image characterization of the features that typically require a comparatively slow X-ray analysis. That is, the herein disclosed methods utilize high sampling SEM in combination with low sampling X-ray measurements to obtain an overall fast and reliable characterization.

Since the BSE yield of SEM is about 1,000 times larger than that of X-ray, the herein disclosed method advantageously enables to reduce the time required to characterize physical parameters of the sample, as only a low sampling rate of X-ray measurements is required.

Advantageously, in some embodiments, the disclosed method enables a fast, non-destructive material characterization at various stages of a device manufacturing process, optimizing the manufacturing process. Advantageously, in some embodiments, the method may provide feedback regarding process tools health, thereby monitoring and facilitating maintaining the process tool health.

Advantageously, in some embodiments, the disclosed method may be implemented on patterned and/or non-patterned wafers during various manufacturing stages thereof.

Advantageously, in some embodiments, the disclosed method may provide substantially full wafer statistics of a patterned and/or a non-patterned wafer.

Advantageously, in some embodiments, the disclosed method combines electron-beam and X-ray technologies to obtain a quantitative analysis of materials/elements of a patterned and/or a non-patterned wafer, thereby facilitating optimizing various stages of a manufacturing process thereof.

According to some embodiments, there is provided a non-destructive method for characterizing a patterned wafer and/or non-patterned wafer, the method including: using a SEM tool to obtain a plurality of SEM images of a tested wafer; analyzing the plurality of SEM images to obtain grey levels thereof, the analyzing comprising executing a structure level segmentation of the plurality SEM images to measure grey levels thereof; and extracting an amount of the feature of interest, the extraction is based, at least in part, on comparing the grey levels with a previously calculated correlation plot between the grey levels and the amount of the feature of interest as determined according to an EDX spectrum, the EDX spectrum comprises one or more of an EDX spectrum of a reference sample and/or a calculated EDX spectrum.

According to some embodiments, the method may be localized, i.e., having an evaluation area of below about 5 square-microns, or of below about 2 square-microns per analyzed site.

According to some embodiments, the method may include executing a statistical process control configured to evaluate a correlation between the extracted amount of the feature of interest and a theoretical amount thereof.

According to some embodiments, analyzing the plurality of SEM images may include obtaining a grey level heat map of the tested wafer.

According to some embodiments, the method may include using an X-ray detector to obtain the EDX spectrum from pre-defined locations on the wafer, wherein a sampling rate of the X-ray detector is lower than a sampling rate of the SEM tool.

According to some embodiments, the pre-defined locations may include locations on the heat map wherein an anomaly of the feature of interest has been identified by the statistical process control of the grey levels.

According to some embodiments, the method may include using the X-ray detector to obtain the EDX spectrum at a pre-defined manufacturing frequency.

According to some embodiments, the method may include obtaining an X-ray heat map of the tested wafer.

According to some embodiments, the method may include outputting instructions including: to continue a wafer manufacturing process, to perform a root cause analysis of the wafer manufacturing process, to perform a root cause analysis of the SEM and/or the X-ray detector.

According to some embodiments, the instructions to perform the root cause analysis of the SEM and/or the X-ray detector may include updating the correlation plot of the feature of interest.

According to some embodiments, the feature of interest may include a plurality (e.g., 2, 3, 4, 5, 10 or more) features of interest. Each possibility is a separate embodiment.

According to some embodiments, the tested wafer may include SiGe, and the feature of interest comprises Germanium (Ge) concentration.

According to some embodiments, the amount of the feature of interest of the reference sample may differ from the amount of feature of interest of the tested wafer.

According to some embodiments, the method may further include a setup phase including: receiving a reference sample comprising a feature of interest;
a. using the SEM tool to acquire a plurality of SEM images of the reference sample;
b. performing a structure level segmentation of the plurality of SEM images to measure grey levels of the reference sample;
c. using the X-ray tool to obtain an EDX spectrum of the reference sample;
d. extracting a physical parameter from the EDX spectrum using simulations that converts the EDX spectra into values of the physical parameter (e.g., concentration of a material, thickness of a layer etc.);
e. building a correlation graph between grey levels and the physical parameter extracted from the EDX spectrum.

According to some embodiments, the method may include defining one or more acceleration voltages of the SEM tool and a geometry of one or more X-ray detectors of the SEM tool.

According to some embodiments, the one or more acceleration voltages (landing energy) of the SEM tool may be in a range of about 1 KV to about 70 KV.

According to some embodiment, the method may include obtaining a grey level heat map of the reference sample.

According to some embodiments, the method may include obtaining an X-ray wafer heat map, the X-ray level heat map comprising an amount of the feature of interest of the reference sample and locations thereof.

According to some embodiments, the computer-implemented simulation may be based, at least in part, on a Monte Carlo simulation.

According to some embodiments, there is provided a system for characterizing a patterned wafer and/or non-patterned wafer, the system including: a scanning equipment comprising: a scanning electron microscope (SEM) configured to obtain a plurality of SEM images of a tested sample, and an X-ray detector configured to obtain an EDX spectrum of sites/location of the tested sample; and a processor configured to execute a code configured to: analyze the plurality of SEM images to obtain grey levels; extract an amount of a feature of interest of the tested sample, based, at least in part on, comparing the grey levels with a previously calculated correlation plot between the grey levels and the amount of the feature of interest as determined according to the EDX spectrum, the EDX spectrum comprises one or more of an EDX spectrum of a reference sample.

According to some embodiments of the system, the X-ray detector may be a part of the SEM tool.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE DRAWINGS

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In block diagrams and flowcharts, optional elements/components and optional stages may be included within dashed boxes.

In the figures:

FIG. 1 presents a block diagram of a system for characterization of specimens, which includes an electron beam source and an X-ray detector, according to some embodiments;

FIG. 2 presents a flowchart of a setup phase of a method for characterization of a specimen, according to some embodiments;

FIG. 3 presents a flowchart of a run time phase of a method for characterization of a specimen, according to some embodiments;

FIG. 4A schematically illustrates an example of grey levels extracted from a plurality of SEM images of a tested sample, according to some embodiments;

FIG. 4B schematically illustrates an example of a grey level heat map, according to some embodiments;

FIG. 4C schematically illustrates an example of a Statistical Process Control (SPC) curve of an amount of a feature of interest or directly the measured grey level value, according to some embodiments;

FIG. 4D schematically illustrates a correlation plot of an amount of a feature of interest of a tested sample vs. obtained grey levels, according to some embodiments;

FIG. 5 is a table showing exemplary action instructions for various SEM and EDX measurements; according to some embodiments.

### DETAILED DESCRIPTION OF THE INVENTION

The principles, uses and implementations of the teachings herein may be better understood with reference to the accompanying description and figures. Upon perusal of the description and figures present herein, one skilled in the art will be able to implement the teachings herein without undue effort or experimentation.

Aspects of the disclosure, according to some embodiments thereof, relate to material characterization using high-sampling rate scanning electron microscope (SEM), in combination with low-sampling rate X-ray measurement to obtain an overall fast and reliable characterization.

Since the BSE yield of SEM is about 1,000 times larger than that of X-ray, the herein disclosed method advantageously enables to reduce the time required to characterize physical parameters of the sample, due to the low sampling rate of X-ray measurements is required.

The present disclosure, according to some embodiments, provides a unified approach combining scanning electron and X-ray technologies. Advantageously, in some embodiments, the disclosed methods and systems enable obtaining a quantitative, fast and accurate material characterization. Advantageously, in some embodiments, the disclosed methods and systems combine the rapidity of electron beam scanning provided by the SEM tool with the quantitative accuracy of the X-ray measurements and/or calculations, thereby enabling obtaining substantially full wafer characteristics of patterned and/or non-patterned wafers/samples. According to some embodiments, the disclosed systems and methods enable performing non-destructive and quantitative characterization of substantially any type of sample suitable for being characterized by a SEM tool.

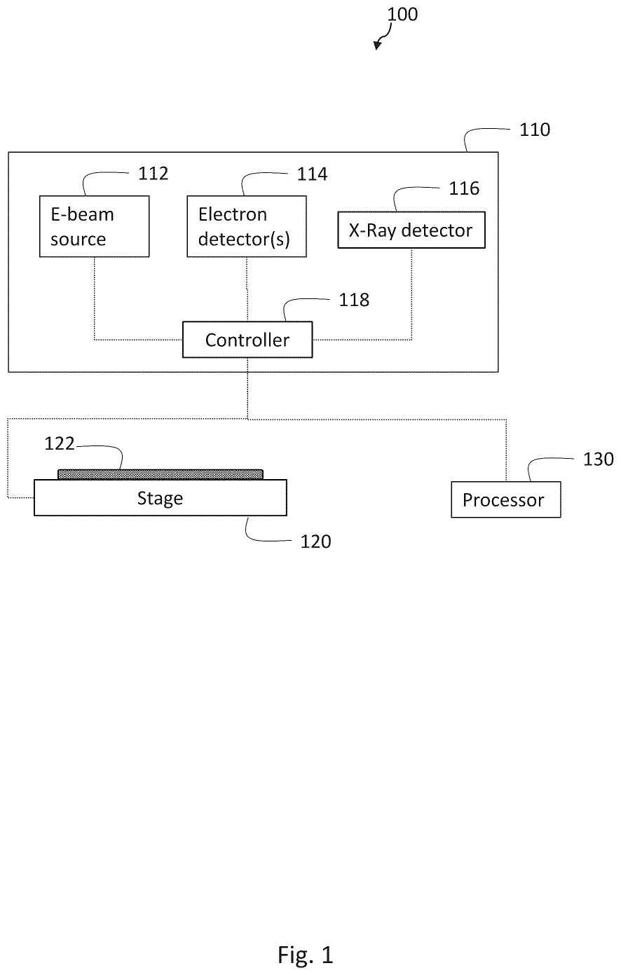

According to an aspect of some embodiments, there is provided a computer-implemented system for sample characterization. As a non-limiting example, there is provided a computer-implemented system for metrology of samples, such as semiconductor samples, devices, wafers, and the like, or any combination thereof, during various stages of a manufacturing process thereof. FIG. 1 presents an example of a block diagram of such a system, a computer-implemented system 100, according to some embodiments. System 100 includes scanning/characterization equipment 110 and at least one processor 130. In some embodiments, at least one processor 130 is in communication with scanning equipment 110.

In some embodiments, scanning equipment 110 includes an electron beam (e-beam) source 112, one or more electron detectors 114 (also referred to as “electron detector(s) 114”), an X-ray detector 116, and a controller 118.

According to some embodiments, electron detector(s) 114 and X-ray detector 116 may be a part of the same characterization/metrology tool. According to some embodiments, electron detector(s) 114 and X-ray detector 116 may be a part of a scanning electron microscopy (SEM) tool.

E-beam source 112, such as an electron gun, is configured to generate an e-beam directed towards a sample 122. According to some embodiments, an acceleration voltage of e-beam source 112 may be in a range of about 1 KV to about 70 KV.

In some embodiments, electron detector(s) 114 is configured to detect electrons emitted from sample 122 as a result of the striking of the e-beam into sample 122. In some embodiments, the electrons emitted from sample 122 may include secondary electrons and/or backscattered electrons emitted therefrom.

In some embodiments, X-ray detector 116 is configured to detect X-ray photons emitted from sample 122 as a result of the striking of the e-beam into sample 122.

In some embodiments, scanning equipment 110 may optionally include one or more optical detectors (not shown). In some embodiments, scanning equipment 110 may optionally include one or more additional detectors, electrostatic lenses, deflectors (e.g., magnetic deflectors), and the like, or any combination thereof.

In some embodiments, at least a portion of scanning equipment 110 may be maintained under vacuum conditions. As a non-limiting example, e-beam source 112 may be housed/maintained in a vacuum chamber (not shown).

According to some embodiments, scanning equipment 110 further includes or is in communication with a stage 120. Stage 120 is configured to accommodate a tested sample 122. In some embodiments, sample 122 may include a solid sample, such as but not limited to, a patterned wafer, a non-patterned wafer, and the like. Each possibility is a separate embodiment.

In some embodiments, sample 122 may include substantially any type of a sample suitable for being characterized by an SEM tool.

According to some embodiments, controller 118 is configured to control the operation of scanning equipment 110. More specifically, in some embodiments, controller 118 may be configured to control and/or synchronize the operation and/or functions of one or more of: e-beam source 112, electron detector 114, X-ray detector 116 and/or stage 122. Each possibility is a separate embodiment. As a non-limiting example, in embodiments wherein stage 122 is movable, stage 122 may be configured to move/translate sample 120 accommodated therein, e.g., along a desired axis, by controller 118. As another non-limiting example, an acceleration voltage of e-beam source 112 may be controlled via controller 118.

According to some embodiments, at least one processor 130 is configured to process data obtained by scanning equipment 110. According to some embodiments, at least one processor 130 may include, among others, memory components, such as but not limited to, a RAM, a non-volatile memory, and the like, and/or any computer hardware components. According to some embodiments, at least one processor 130 may include or be in communication with software components, hardware components, and/or with a user interface.

According to some embodiments, at least one processor 130 may be configured to process signals/images detected by electron detector(s) 114. According to some embodiments, at least one process 130 may be configured to obtain/extract grey levels from a plurality of SEM images, as elaborated in greater detail elsewhere herein. According to some embodiments, at least one processor 130 may be configured to extract/calculate an amount of a feature of interest of a tested sample. According to some embodiments, at least one processor 130 may be configured to execute a code configured to calculate a calibration plot of the grey levels obtained from the plurality of SEM images and the EDX spectrum, as elaborated in greater detail elsewhere herein. According to some embodiments, at least one process 130 may be configured to execute a code configured to calculate a correlation plot of the grey levels obtained from the plurality of SEM images and amounts of the feature of interest, as elaborated in greater detail elsewhere herein. As a non-limiting example, at least one processor 130 may be configured to execute a code configured to obtain a grey levels heat map and/or an X-ray heat map, as elaborated in greater detail elsewhere herein.

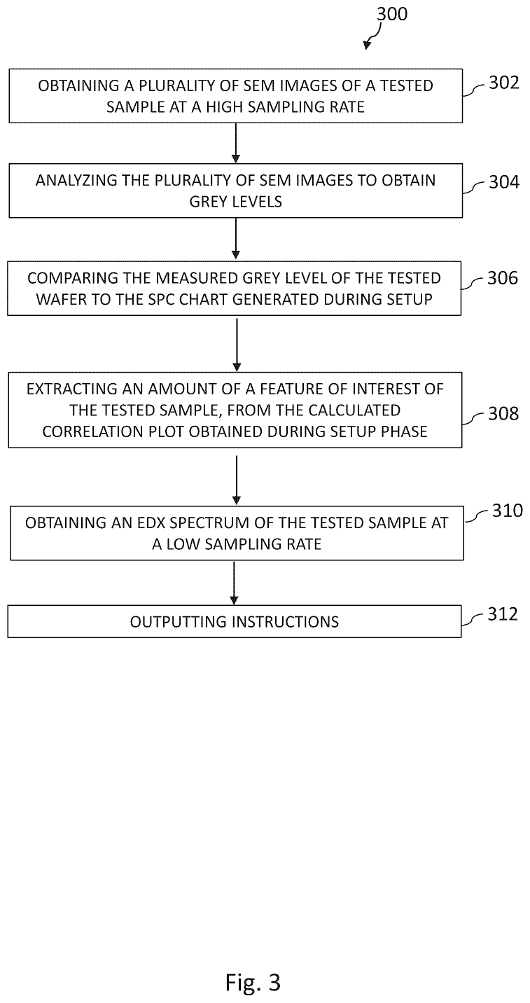

According to some embodiments, at least one processor 130 may be configured to execute a code configured to output instructions, e.g., as elaborated in greater detail FIG. 3.

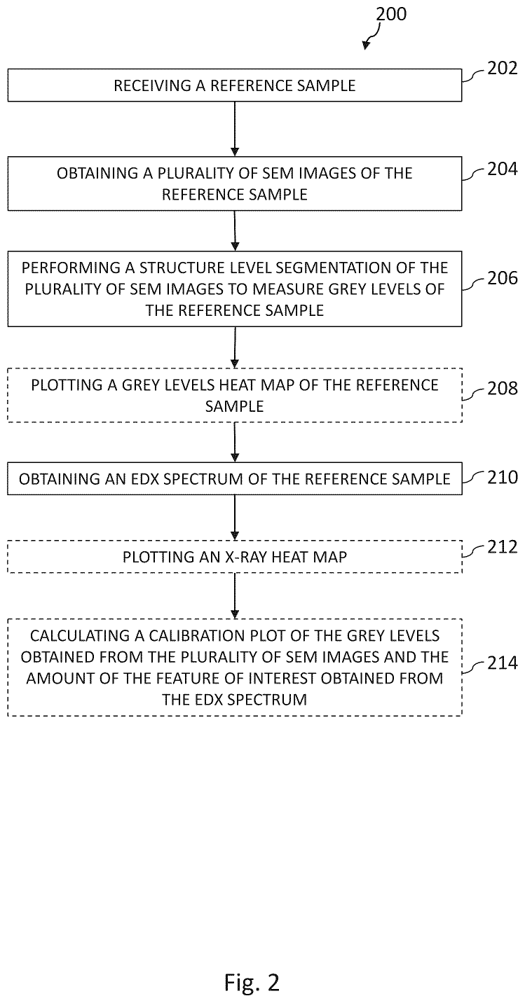

According to an aspect of some embodiments, there is provided a method for characterizing samples. According to some embodiments, the method may include a setup phase and a runtime phase. According to some embodiments, the setup phase is configured to obtain a correlation plot between amounts of a feature of interest and grey levels, as described in greater detail in FIG. 2. According to some embodiments, the runtime phase may be configured for run-time process monitoring, as described in greater detail in FIG. 3.

Reference is made to FIG. 2, which shows a flowchart 200 of a setup phase of a method for characterizing samples, according to some embodiments. According to some embodiments, the sample may include, among others, patterned and/or non-patterned wafers, semiconductor devices or components thereof at various manufacturing stages.

According to some embodiments, the setup phase may be performed prior to characterizing a tested sample. According to some embodiments the setup phase may be configured to calibrate and/or obtain a correlation plot, as described in greater detail elsewhere herein.

According to some embodiments, at step 202, the method includes receiving a reference sample. According to some embodiments, the reference sample includes a feature of interest. According to some embodiments, the reference sample may include a known amount of the feature of interest. According to some embodiments, the known amount of the feature of interest may be substantially equal to an expected amount thereof in the tested sample. Alternatively, or additionally, the reference sample may include a different amount, yet in a same regime as that of the feature of interest in the tested sample. As a non-limiting example, the test wafers may have ±5% of Ge At% in relation to the reference wafer. As another non-limiting example, the layer thickness of a test wafer may be ±20% as compared to the reference thickness.

According to some embodiments, the reference sample may include a plurality of reference samples, wherein each of the plurality of reference samples having a different amount of the feature of interest.

According to some embodiments, at step 204, the method includes obtaining a plurality of SEM images of the reference sample. Put differently, step 204 includes using a SEM tool to acquire the plurality of SEM image of the reference sample.

In some embodiments, step 204 may optionally include defining one or more acceleration voltages of an electron source/gun of the SEM tool for acquiring the plurality of SEM images. According to some embodiments, the plurality of SEM images may be obtained by using a single acceleration voltage. Alternatively, in some embodiments, the plurality of SEM images may be obtained by using a plurality of acceleration voltages. Each possibility is a separate embodiment.

According to some embodiments, the acceleration voltage of the SEM (and/or the plurality of acceleration voltages) may be in a range of about 1 KV to about 70 KV, about 1 KV to about 5 KV, about 4 KV to about 10 KV, or about 10 KV to about 70 KV, or any range therebetween. Each possibility is a separate embodiment. As a non-limiting example, the acceleration voltage may include any one or more of: about 1 KV, about 2 KV, about 3 KV, about 4 KV, about 5 KV, about 6 KV, about 7 KV, about 8 KV, about 9 KV, about 10 KV, about 20 KV, about 30 KV, about 50 KV or about 70 KV or any range/value therebetween. Each possibility is a separate embodiment.

According to some embodiments, the plurality of SEM images may be obtained using any suitable mode of the SEM tool, such as but not limited to detecting backscattered electrons emitted from the reference sample.

According to some embodiments, the plurality of SEM images may be obtained from one or more pre-defined sites/locations on the reference sample. According to some embodiments, the plurality of SEM images may be obtained from any one of: a top view, a side view, tilted and/or non-tilted mode, or any combination thereof. The plurality of SEM images may be obtained using any suitable operation mode of the SEM tool.

According to some embodiments, at step 206, the method includes performing/executing a structure level segmentation of the plurality of SEM images to measure/extract grey levels of the plurality of SEM images of the reference sample. According to some embodiments, the structure level segmentation may be configured to identify sites/locations on the reference sample having different amounts of the feature of interest.

According to some embodiments, the structure level segmentation may be performed by a computer-implemented algorithm(s). According to some embodiments, the computer-implemented algorithm may include, among others, machine learning algorithms, image processing algorithms, and the like.

According to some embodiments, measuring/extracting the grey levels from the plurality of SEM images may be based, at least in part, on a contrast of each of the plurality of SEM images. According to some embodiments, the contrast types of the plurality of SEM images may be based on a sample composition, sample density, and/or on variations in atomic number (“Z”) of elements in the sample, and the like. It may be understood by the skilled in the art that elements having high atomic number appear brighter in backscattered images of a SEM tool, while low atomic number elements appear darker therein.

According to some embodiments, at step 208, which is an optional step, the method may include plotting a grey level heat map of one or more features of interest at different sites/locations of the reference sample. According to some embodiments, the grey level heat map may be based, at least in part, on the grey levels measured from the plurality of SEM images.

According to some embodiments, at step 210, the method includes obtaining a measured EDX spectrum of the reference sample.

In some embodiments, the method may include executing a code configured to compute one or more physical parameters from the measured EDX spectrum. In some embodiments, computing the one or more physical parameters from the measured EDX spectrum comprises applying a simulation. In some embodiments, the one or more physical parameters may be computed based on a ground truth correlation between the EDX spectrum and a known value of the feature of interest as measured for example by TEM. In some embodiments, the one or more physical parameters may be computed by utilizing both simulation and ground truth data.

In some embodiments, the computer-implemented simulation and modelling may be based, at least in part, on a Monte Carlo simulation. In some embodiments, the computer-implemented simulation may include any suitable statistical-based types of simulations/algorithms, machine learning algorithms, and the like.

In some embodiments, the computer-implemented simulation and modelling may be based, at least in part, on executing a code configured to calculate/evaluate the interactions occurring in the sample due to the electron beam emitted from the electron gun/source and hitting/penetrating the sample. In some embodiments, the computer-implemented simulation and modelling may be based, among others, on executing a code configured to calculate/evaluate a volume of interaction within the sample due to the electron beam striking. In some embodiments, the interactions may include, among others, calculating/evaluating collisions, at least partial energy transfer, scattering, and the like, or any combination thereof. In some embodiments, the interactions are calculated until the electron energy significantly decays/diminishes, e.g., approaching, or substantially being equal to, about zero.

In some embodiments, the computer-implemented simulation and modelling may include on executing a code configured to calculate/evaluate the probability to emit an X-ray photon having a specific/characteristic energy/wavelength at each of the interactions. Thus, in some embodiments, enabling obtaining simulated EDX spectra.

In some embodiments, the method includes using an X-ray detector to obtain the EDX spectrum. According to some embodiments, an electron source/gun may be implemented to cause emission of the X-ray photons from the reference sample. It may be understood by the skilled in the art that an electron beam emitted from an electron source/gun of the SEM tool may lead to emission of electrons as well as X-ray photons from a sample.

It may be further understood by the skilled in the art that each element has a characteristic atomic structure, forming a unique set of peaks of X-ray spectrum thereof. Hence, exciting atoms of the reference sample, results in emitting X-ray photons having a characteristic identity (i.e., unique energetic signature), thereby enabling characterizing/identifying the elemental composition of the reference sample.

According to some embodiments, at step 212, which is an optional step, the method may include plotting an X-ray photons heat map of the amounts/values of the one or more features of interest at different sites/locations of the reference sample. According to some embodiments, the X-ray heat map may be based, at least in part, on the X-ray photons detected from the EDX spectrum. According to some embodiments, the X-ray heat map may be based, at least in part, on the physical parameter computed from the EDX spectrum.

According to embodiments, at step 214, which is an optional step, a correlation graph between grey levels derived from the SEM measurements and the physical parameter extracted from the EDX spectrum is built.

According to some embodiments, the correlation graph is a graph showing the grey level as a function of the amount/value of the physical parameter. According to some embodiments, the correlation graph is a graph showing the amount/value of the physical parameter as a function of the grey level.

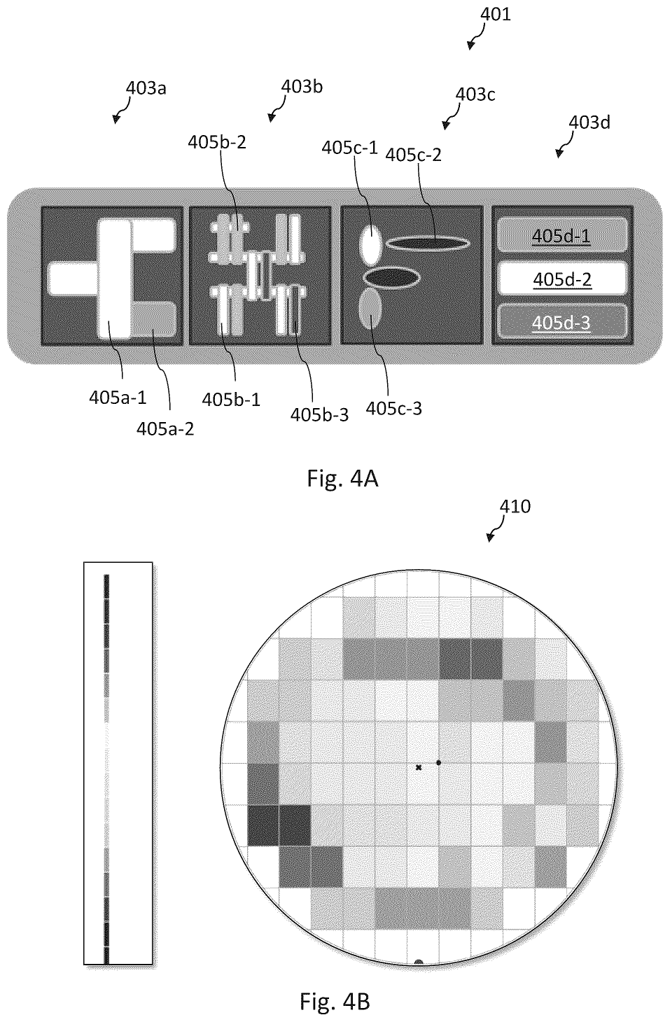

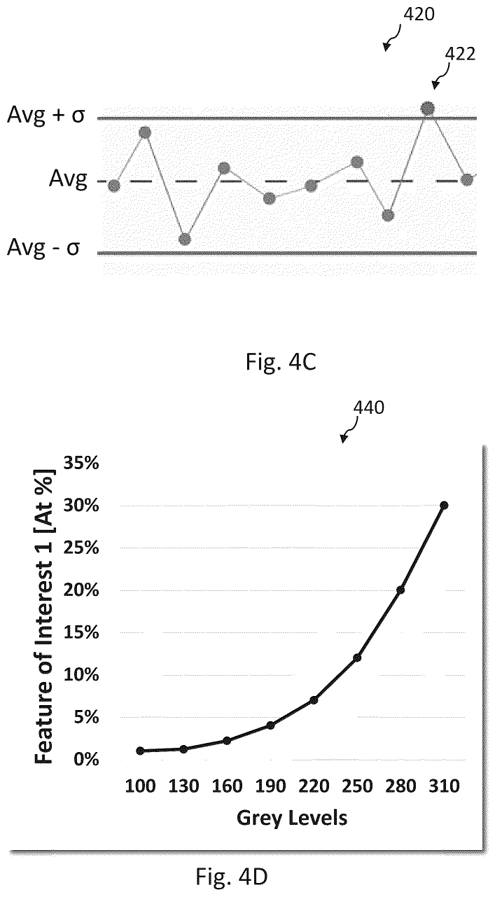

Reference is made to FIG. 3, which shows a flow chart 300 of a runtime phase of a method for characterizing samples, and to FIGS. 4A-D, which schematically illustrate examples of some of the steps of the method, according to some embodiments. According to some embodiments, the method may be implemented using system 100 or a system similar thereto.

According to some embodiments, at step 302, the method may include using a SEM tool to obtain a plurality of SEM images of a tested sample at a high sampling rate (e.g., about 10-20 sites of a wafer). In some embodiments, the tested sample may include, among others, a tested wafer, such as a patterned wafer, a non-patterned wafer, a multi-layered sample, a semiconductor device or a component/portion thereof, an integrated circuit and/or a component/portion thereof, and the like.

In some embodiments, at step 302, the method may include performing high sample/wafer sampling by an electron beam emitted from an e-beam source of the SEM tool. Advantageously, in some embodiments, the high sample/wafer sampling is a fast process. As a non-limiting example, the high sample/wafer sampling may be performed during any step of a wafer manufacturing process, e.g., to identify sample/wafer defects (such as defects related to variations in the amount of the feature of interest), assess quality of the sample/wafer and/or machinery performance and/or health during a sample/wafer manufacturing process, and the like, or any combination thereof.

According to some embodiments, the plurality of SEM images may be obtained based on backscattered electrons emitted from the tested sample, due to the interactions with an incident e-beam. According to some embodiments, at least a portion of the plurality of SEM images may be obtained using a tilted operation mode of a SEM (i.e., images obtained at non-normal angles). According to some embodiments, the plurality of SEM images may be obtained at one or more acceleration voltage, landing energy sweep, and the like, or any combination thereof.

In some embodiments, at least a portion of the plurality of SEM images may include unprocessed plurality of SEM images and/or data extracted from the plurality of SEM images of the tested sample. Alternatively, or additionally, in some embodiments, at least a portion of the SEM images may be processed, e.g., by implementing machine learning algorithms, image processing techniques, and the like, or a combination thereof.

According to some embodiments, the plurality of SEM images may be obtained at a specific/pre-defined acceleration voltage. Alternatively, or additionally, in some embodiments, the plurality of SEM images may be obtained at one or more acceleration voltages. According to some embodiments, the one or more acceleration voltages of a SEM tool used to obtain the plurality of SEM images may be in a range of about 1 KV to about 70 KV, about 1 KV to about 50 KV, about 10 KV to about 70 KV, about 1 KV to about 25 KV, about 25 KV to about 70 KV, and the like. Each possibility is a separate embodiment.

According to some embodiments, the plurality of SEM images may be obtained at a specific/pre-defined incident angle of the e-beam. Alternatively, or additionally, in some embodiments, the plurality of SEM images may be obtained at different incidence angles of the e-beam. Each possibility is a separate embodiment.

According to some embodiments, the plurality of SEM images may include a predefined number of images of pre-defined sites/locations of the sample. According to some embodiments, the pre-defined number of images may vary.

According to some embodiments, the plurality of SEM images may include a top view, a side view, or any other type of a view of the tested sample, or any combination thereof.

According to some embodiments, at step 304, the method may include analyzing the plurality of SEM images to obtain/extract grey levels thereof. According to some embodiments, the grey levels may be obtained from a pre-defined site/location on the tested sample. Alternatively, in some embodiments, the grey levels may be obtained from a plurality of sites/locations on the tested sample. In some embodiments, the grey levels may be obtained substantially from the whole tested sample, a layer, a pattern, and the like. Each possibility is a separate embodiment. As a non-limiting example, the grey levels may be obtained from a specific layer of the tested sample.

According to some embodiments, analyzing the plurality of SEM images may include executing a structure level segmentation thereof to measure/obtain the grey levels of the plurality of SEM images. Alternatively, or additionally, in some embodiments, analyzing the plurality of SEM images may be performed by any suitable method.

A non-limiting example of step 306 is schematically illustrated in FIG. 4A, which shows an example of grey levels extracted from a plurality of SEM images of a tested sample. More specifically, according to some embodiments, FIG. 4A schematically illustrates a top view image of a patterned wafer 401 having a plurality of regions 403a-d, according to some embodiments. According to some embodiments, and as schematically depicted in FIG. 4A, each of plurality of regions 403a-d may be substantially on the same plane (i.e., substantially at the same height) of patterned wafer 401. Alternatively, in some embodiments, each of plurality of regions 403a-d may be stacked one above the other. According to some embodiments, a first portion of the plurality of regions 403a-d may be stacked one above the other, and a second portion thereof (i.e., a remainder thereof) may be positioned at one or more planes of patterned wafer 401. Each possibility is a separate embodiment.

According to some embodiments, a first region 403a of plurality of regions 403a-d may include a first pattern having a first grey level region 405a-1 and a second grey level region 405a-2. According to some embodiments, first and second regions 405a-1 and 405a-2 have different grey levels values. Accordingly, first and second regions 405a-1 and 405a-2 may have different compositions, different concentrations (e.g., atomic percent, weight percent) of the same element(s) or of different elements, and the like, or any combination thereof. Similarly, in some embodiments, a second region 403b may include a second pattern having a first grey level region 405b-1, a second grey level region 405b-2 and a third grey level region 405b-3. According to some embodiments, a third region 403c may include a third pattern having a first grey level region 405c-1, a second grey level region 405c-2 and a third grey level region 405c-3; and a fourth region 403d may include a pattern having a first grey level region 405d-1, a second grey level region 405d-2 and a third grey level region 405d-3. In some embodiments, the number of plurality of regions 403a-d may vary. In some embodiments, the number, size, dimension/shape of each of the grey levels regions may vary.

In some embodiments, a tested sample/wafer may have one region (i.e., site/location) having one or more grey levels regions (e.g., a plurality of grey levels regions, embodiment not shown).

According to some embodiments, analyzing the plurality of SEM images may optionally include plotting a grey level heat map of the tested sample/wafer. A non-limiting example of a grey levels heat map 410 of the tested sample is schematically illustrated in FIG. 4B. As schematically depicted in FIG. 4B, grey levels heat map 410 includes a plurality of sites/locations of a tested wafer having different values of the grey levels.

According to some embodiments, at step 306, the method may optionally include comparing the measured grey level of the tested wafer to the Statistical Process Control (SPC) chart generated during setup. It is understood, that based on the SPC correlation graph, the grey level values that are considered as out-of-spec per a specific structure can easily be determined.

A non-limiting example of step 306 is schematically depicted in FIG. 4C, which shows a schematic example of a curve 420 of a grey level of a tested sample. According to some embodiments, and as depicted in FIG. 4C, the curve may include statistical parameters related to the grey level. According to some embodiments, the statistical parameters of curve 420 may include parameters of a Gaussian distribution. Alternatively, in some embodiments, the statistical parameters of curve 420 may include parameters of any other suitable statistical distribution.

According to some embodiments, and as depicted in FIG. 4C, the curve shows an average (marked as a dashed line “Avg”) value of the grey level. In some embodiments, the average value may be substantially equal to an expected/theoretical value of the feature of interest of the reference sample. According to some embodiments, the curve may include a predefined variation around the average grey level. More specifically, according to some embodiments and as depicted in FIG. 4C, curve 420 includes a pre-defined allowed maximum and minimum amounts of the grey level, marked as Avg+σ and Avg−σ, respectively. Hence, in some embodiments, grey levels in a range between Avg−σ and Avg+σ may be defined as allowed/proper values thereof, while grey levels falling outside the range between Avg−σ and Avg+σ, e.g., may be considered as anomaly, defect and/or failure.

Optionally, in some embodiments, the anomaly in the grey level may be included in the grey level heat map of the tested sample. In some embodiments, a location and/or coordinates of the location of the anomaly may be included in the grey level heat map of the tested sample.

In some embodiments, the identified anomalous amounts of the grey level may optionally require performing further actions, such as a route cause analysis, as elaborated in greater detail at step 312.

In some embodiments, method 300 may include a step 308 of calculating/extracting an amount/value of the feature of interest from the correlation plot obtained during setup.

According to some embodiments, extracting the amount of the feature of interest may include extracting a concentration (e.g., atomic %, weight %, and the like) of the feature of interest. According to some embodiments, the method may include extracting an absolute concentration of the feature of interest in the tested sample. Put differently, in some embodiments, the method may include obtaining a quantitative analysis of the feature of interest in the tested sample.

In some embodiments, the previously calculated correlation plot is obtained at the setup phase of the method, e.g., as described in FIG. 2. In some embodiments, the previously calculated correlation plot may include an expected (also referred to as “design intent”) amount of the feature of interest in the pre-defined sites/location of the tested sample/wafer. It may be understood that different sites/locations of the tested sample/wafer may include different amounts (e.g., different concentrations) of the feature of interest therein.

A non-limiting example of step 308 is schematically illustrated in FIG. 4D, which shows an example of a plot 440 of an amount of feature of interest of a tested sample/wafer vs. the grey levels, respectively, according to some embodiments.

According to some embodiments, at step 310, the method includes obtaining/measuring an EDX spectrum of the tested sample/wafer at a low sampling rate, as further elaborated herein.

In some embodiments, obtaining the EDX spectrum may be triggered by the grey level SPC, be executed at a pre-determined number and/or sites/locations of the tested sample/wafer. Each possibility is a separate embodiment. According to some embodiments, as long as the grey level is according to the specification, no EDX analysis may be performed.

According to some embodiments, obtaining an EDX spectrum at a low sampling rate may include, among others, obtaining the EDX spectrum each pre-defined number of tested samples. As a non-limiting example, the EDX spectrum may be obtained/acquired about every 25 wafers/samples, every 10 wafers/samples, every 5 wafers/samples or any range therebetween. Each possibility is a separate embodiment. As another non-limiting example, the EDX spectrum may be obtained/acquired for 1/30 of the locations examined by the SEM, 1/10 of the locations examined by the SEM, or for 1/5 of the locations examined by the SEM. Each possibility is a separate embodiment. As another non-limiting example, the EDX spectrum may be obtained/acquired at a sampling range sufficiently high to ensure inspection quality yet sufficiently low to ensure a high throughput.

According to some embodiments, obtaining an EDX spectrum at a low sampling rate may include, among others, obtaining the EDX spectrum at a pre-determined time interval during the manufacturing process. Thereby, in some embodiments, facilitating monitoring the manufacturing process and maintaining quality standards and reliability thereof. According to some embodiments, the pre-defined manufacturing frequency may include, among others, obtaining the EDX spectrum about every 10 minutes, every 30 minutes during the manufacturing process on the production line, about every 1 hour, about every 2 hours, and the like.

According to some embodiments, obtaining an EDX spectrum at a low sampling rate may include obtaining the EDX spectrum only when an anomaly of the feature of interest has been identified by the grey level SPC (e.g., at point 422 in FIG. 4C). According to some embodiments, the anomaly may include an absence, deficiency or an excess amount of the feature of interest as extracted from the grey level SPC.

According to some embodiments, the EDX spectrum may be obtained from pre-defined sites/locations of the tested sample/wafer. In some embodiments, at least a portion of sites/locations captured in the plurality of SEM images may be characterized by an EDX analysis to obtain the EDX spectrum therefrom.

According to some embodiments, a sampling rate of obtaining the EDX spectrum (of the X-ray detector) is lower than a sampling rate of obtaining the plurality of SEM images of step 302. Put differently, in some embodiments, the X-ray detector may have a lower sampling rate than the sampling rate of grey level.

According to some embodiments, obtaining the EDX spectrum in step 310 further includes extracting the amount of the feature of interest based, at least in part, on the computer-implemented simulation and modelling described for the setup phase.

According to some embodiments, at step 312, method 300 may include outputting instructions. According to some embodiments, the instructions may be outputted to a user and/or to a tool, a production line, and the like, or any combination thereof.

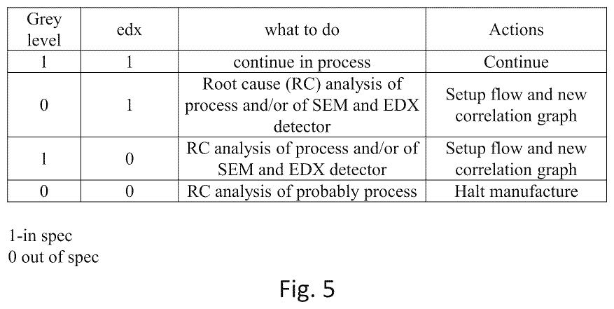

According to some embodiments, the instructions may include actions of continuing sample/wafer manufacturing process. As a non-limiting example, the instructions to continue in the manufacturing process may be outputted in scenarios in which the extracted amount of a feature of interest corresponds to a correlation plot obtained at the setup phase (i.e., the measurement is within spec), thereby rendering the sample/wafer as a properly manufactured sample. As another non-limiting example, as set forth in row 1 of the table of FIG. 5, the instructions to continue in the process may be outputted in scenarios in which the extracted amount of the feature of interest according to the grey levels (such as a grey levels heat map) correspond to the amount of the feature of interest according to the obtained EDX spectrum thereof (such as an X-ray heat map), thereby rendering the sample/wafer as a properly manufactured sample. As another non-limiting example, the instructions to continue the process may be outputted in scenarios in which the extracted amount of the feature of interest is devoid of anomaly amounts.

According to some embodiments, the instructions may include performing a root cause analysis of the manufacturing process, a root cause analysis of a SEM tool or components thereon, and/or a root cause analysis of an X-ray detector.

According to some embodiments, in scenarios in which the grey levels indicated an anomaly in the amount of feature of interest, while the EDX spectrum indicated a different and/or proper amount thereof (row 2 of the table of FIG. 5), the instructions may include performing a root cause analysis of the manufacturing process/line and/or a root cause analysis related to the SEM tool and/or components thereof and/or of the EDX detector. That is, an inspection is made to understand which of the measurements (the grey level or EDX) were incorrect, i.e., which of the measurements correspond to the process evaluation output.

According to some embodiments, the root cause analysis of the SEM tool may include, among others, a root cause analysis of an e-beam source/gun, electron detector(s), vacuum levels, a SEM hardware analysis, or any combination thereof. In some embodiments, when a root cause analysis has been completed, the method may include updating/re-executing the correlation plot between the grey level of the SEM tool and the amount/value of the feature of interest derived from the EDX spectrum (e.g., of the setup phase of the method).

According to some embodiments, in scenarios in which the grey levels indicated a proper amount of a feature of interest, while the EDX spectrum indicated an anomaly in the amount thereof (row 3 of the table in FIG. 5), the instructions may include performing a root cause analysis of the manufacturing process/line and/or a root cause analysis related to the SEM tool and/or of the X-ray detector. In some embodiments, the instructions to perform the root cause analysis of the SEM tool and/or of the X-ray detector may include updating the correlation plot of the feature of interest (e.g., of the setup phase of the method).

According to some embodiments, in scenarios in which both the grey levels and the EDX spectrum indicated an anomaly in the amount of feature of interest, the instructions may include performing a root cause analysis of the manufacturing process and optionally to halt manufacturing until fixing the underlying cause.

In the description, various aspects of the invention was described. For the purpose of explanation, specific details were set forth in order to provide a thorough understanding of the invention. However, it is apparent to one skilled in the art that the invention may be practiced without specific details being presented herein. Furthermore, well-known features may be omitted or simplified in order not to obscure the invention.

As used herein, according to some embodiments, the term “feature of interest” may refer to any type of material in a tested sample. According to some embodiments, the term “feature of interest” may refer to a single or to a plurality of features of interest. According to some embodiments, the feature of interest may include one or more of the following: an atom, an ion, a compound, and the like. According to some embodiments, the feature of interest may include any element detectable by an energy-dispersive X-ray spectroscopy (EDX). As another non-limiting example, the feature of interest may include, among others, Germanium (Ge), Tungsten (W), Tantalum (Ta), and the like, or any combination thereof. As another non-limiting example, a tested sample may include a layer, a region or a pattern including SiGe, and the feature of interest thereof may include Germanium (Ge).

According to some embodiments, the feature of interest may include any type of an element or a composition of a portion of a tested sample. According to some embodiments, the feature of interest may include one or more dopants of a tested sample. As a non-limiting example, the feature of interest may include a portion of a composition of a wafer, a portion of a composition of a semiconductor device/component, and the like. As a non-limiting example, the feature of interest may include one or more dopants of a wafer. As another non-limiting example, the feature of interest may include elements of a layer, coating, section, substrate, a pattern, and the like, of a tested sample. Each possibility is a separate embodiment.

As used herein, according to some embodiments, the term “tested sample” may include any type of a sample or a portion thereof suitable for characterization at a SEM tool. According to some embodiments, the tested sample may refer to a solid sample, such as but not limited to, wafers, thin films, multi-layered samples/structures, patterned samples, non-flat samples, coated or uncoated samples, and the like. Each possibility is a separate embodiment.

Currently employed material metrology methods include performing long cycles and using destructive methods, and which typically have a poor correlation between blanket wafer measurements and patterned structures, due to a micro loading effect.

In the description and claims of the application, the words “include” and “have”, and forms thereof, are not limited to members in a list with which the words may be associated.

As used herein, the term “about” may be used to specify a value of a quantity or parameter to within a continuous range of values in the neighborhood of (and including) a given (stated) value. According to some embodiments, “about” may specify the value of a parameter to be between 80 % and 120 % of the given value. For example, the statement “the length of the element is equal to about 1 m” is equivalent to the statement “the length of the element is between 0.8 m and 1.2 m”. According to some embodiments, “about” may specify the value of a parameter to be between 90 % and 110 % of the given value. According to some embodiments, “about”may specify the value of a parameter to be between 95 % and 105 % of the given value.

As used herein, according to some embodiments, the term “amount” may refer to a concentration of a feature of interest, such as, but not limited to, at. %, wt. %, and the like.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

What is claimed is:

1. A non-destructive and localized method for characterizing a wafer manufacturing process, the method comprising:
using a SEM tool to obtain a plurality of SEM images of a plurality of locations of a tested wafer;
analyzing the plurality of SEM images to obtain grey levels thereof, the analyzing comprising executing a structure level segmentation of the plurality SEM images to measure grey levels thereof;
comparing the measured grey level of the tested wafer to the statistical process control (SPC) correlation graph to determine whether or not the measured grey level is within or outside a predetermined specified range, wherein the SPC correlation graph is generated during a setup phase;
extracting an amount of the feature of interest based, at least in part, on a correlation plot between grey level and the amount of the feature of interest, wherein the correlation plot is generated during the setup phase;
acquiring EDX spectra for only a subset of the plurality of locations;
determining the amount of the feature of interest, based on the EDX spectra;
determining whether the amount of the feature of interest obtained from the EDX spectra is within a specified range; and
outputting action instructions depending on the amount of the feature obtained by the SEM measurement and the EDX spectra.

2. The method of claim 1, wherein the action instructions depend on:
a) a degree of correspondence between the amount of the feature of interest as derived from the grey level and the amount of the feature of interest as derived from the EDX spectra; and
b) whether the amount of the feature, as determined by the grey level and the EDX spectra, both fall within a prespecified range.

3. The method of claim 1, enabling determining the amount of the feature in a shorter time as compared to determining the amount of the feature using EDX only.

4. The method of claim 1, wherein analyzing the plurality of SEM images comprises obtaining a grey level heat map of the tested wafer.

5. The method of claim 1, wherein the subset of locations comprise locations for which an anomaly of the feature of interest has been identified according to the grey level SPC.

6. The method of claim 1, wherein the subset of locations comprises between 1/5 to 1/30 of the plurality of locations examined by the SEM.

7. The method of claim 1, wherein, when the amount of the feature, as determined by of the grey level and the EDX spectra, both fall within the prespecified range, the action instructions comprise instructions to continue the wafer manufacturing process.

8. The method of claim 1, wherein when the amount of the feature of interest as determined from one of the grey level and the EDX spectra is within the prespecified range and the other is outside the prespecified range, the action instructions comprises conducting a root cause analysis of the manufacturing process and of the SEM tool and/or the EDX detector.

9. The method of claim 8, wherein following the root cause analysis of the SEM tool and/or the EDX detector, the method further comprises updating the SPC correlation graph.

10. The method of claim 1, wherein, when the amount of the feature, as determined by of the grey level and the EDX spectra, both fall outside the prespecified range, the action instructions comprise conducting a root cause analysis of the manufacturing process.

11. The method of claim 1, wherein the feature of interest comprises a plurality of features of interest.

12. The method of claim 1, wherein the tested wafer comprises SiGe, and wherein the feature of interest comprises Germanium (Ge) concentration.

13. The method of claim 1, further comprising a setup phase comprising:
receiving a reference sample comprising a feature of interest;
using the SEM tool to acquire a plurality of SEM images of the reference sample;
performing a structure level segmentation of the plurality of SEM images to measure grey levels of the reference sample;
obtaining an EDX spectrum of the reference sample;
calculating, by applying a computer-implemented simulation and modelling, the amount of the feature of interest from the EDX spectrum; and
generating the SPC correlation graph by associating the grey level with the amount of the feature of interest calculated from the EDX spectrum.

14. The method of claim 13, comprising defining one or more acceleration voltages of the SEM tool and a geometry of one or more X-ray detectors of the SEM tool.

15. The method of claim 14, wherein the one or more acceleration voltages of the SEM tool are in a range of about 1 KV to about 70 KV.

16. The method of claim 15, further comprising obtaining a grey level heat map of the reference sample.

17. The method of claim 15, further comprising obtaining an X-ray wafer heat map, the X-ray level heat map comprising an amount of the feature of interest of the reference sample and locations thereof.

18. The method of claim 13, wherein the computer-implemented simulation is based, at least in part, on a Monte Carlo simulation.

19. A system for characterizing a patterned wafer and/or non-patterned wafer, the system comprising:
scanning equipment comprising:
a scanning electron microscope (SEM) configured to obtain a plurality of SEM images of a tested sample; and
an X-ray detector configured to obtain an EDX spectrum of sites/location of the tested sample; and
a processor configured to execute a code configured to:
analyze the plurality of SEM images to obtain grey levels thereof, the analyzing comprising executing a structure level segmentation of the plurality SEM images to measure grey levels thereof;
comparing the measured grey level of the tested wafer to a statistical process control (SPC) chart to determine whether or not the measured grey level is within or outside a predetermined specified range, wherein the SPC correlation graph is generated during a setup phase of the system;
extract an amount of the feature of interest based, at least in part, based on a correlation plot between grey level and the amount of the feature of interest;
acquire EDX spectra for only a subset of the plurality of locations;
determine the amount of the feature of interest, based on the EDX spectra;
determine whether the amount of the feature of interest obtained from the EDX spectra is within a specified range; and
output action instructions depending on the amount of the feature obtained by the SEM measurement and the EDX spectra.

20. The system of claim 19, wherein the action instructions depend on:
a) a degree of correspondence between the amount of the feature of interest as derived from the grey level and the amount of the feature of interest as derived from the EDX spectra; and
b) whether the amount of the feature, as determined by the grey level and the EDX spectra, both fall within a prespecified range.
